(19) United States
(12) Patent Application Publication
(10) Pub. No.: US 2025/0316855 A1
(43) Pub. Date: Oct. 9, 2025

(54) CONNECTION DEVICE

(71) Applicant: A. Raymond et Cie, Grenoble (FR)

(72) Inventor: Etienne Brichet-Billet, Grenoble (FR)

(21) Appl. No.: 18/709,308

(22) PCT Filed: Oct. 11, 2022
(86) PCT No.: PCT/EP2022/078240

§ 371 Date: Oct. 24, 2024

(30) Foreign Application Priority Data
Nov. 10, 2021 (FR) FR2111926

(51) Int. Cl. H01M 50/517; H01M 50/503; H01R 13/18; H01R 13/193

(52) U.S. Cl. CPC H01M 50/517; H01M 50/503; H01R 13/18; H01R 13/193

(57) ABSTRACT

A connection device comprises:—a casing;—a connection element;—a clamping clip; and—a movable element that comprises two lateral wings on either side of the clamping clip. The movable element is able to take a raised position and a lowered position. The lowered position is a position in which the movable element leaves the clamping clip in its free state, whereas the raised position is a position in which the lateral wings have a spacing, called the first spacing, that is greater than a spacing, called the second spacing, observed in the lowered position. The lateral wings exert. on each of the clamping wings, a force opposing the spring action, which causes the clamping wings to be spaced apart.

### CROSS REFERENCE TO RELATED APPLICATIONS

This application is a national phase entry under 35 U.S.C. § 371 of International Patent Application PCT/EP2022/078240, filed Oct. 11, 2022, designating the United States of America and published as International Patent Publication WO 2023/083544 A1 on May 19, 2023, which claims the benefit under Article 8 of the Patent Cooperation Treaty to French Patent Application Serial No. FR2111926, filed Nov. 10, 2021.

### TECHNICAL FIELD

The present disclosure relates to the field of modular batteries, and more particularly to the field of connector technology. Notably, the present disclosure relates to an inter-battery connection device.

### BACKGROUND

An inter-battery connection device known from the prior art is disclosed in document EP3358647.

In particular, and as shown in [FIG. 12] of document EP3358647, this device comprises a U-shaped connection clip defining a U-shaped channel wherein a connection tab of a battery can be inserted and held by spring action of the connection clip.

The connection device also comprises a movable element capable of adopting one or the other of a disengaged position and an engaged position, and which is provided with at least one wedge engaged in the U-shaped channel.

The wedge is, in particular, arranged so that the connection clip has a spacing that is dependent on the position of the movable element. In this respect, the disengaged position and the engaged position are positions of the movable element for which the wedge imposes on the wings of the connection clip, respectively, a first spacing and a second spacing that is less than the first spacing.

Thus, when connecting the connection device to a connection tab of a battery, the movable element is first in its disengaged position in order to provide a sufficient spacing (the first spacing) of the wings of the connection clip and thus allow the insertion of the connection tab into the U-shaped channel. This insertion is then followed by a movement of the movable element from its disengaged position to its engaged position so that the wings of the connection clip are tightened against the tab and maintain the latter by spring action.

Although this device is easy to use, it is not satisfactory.

Indeed, the connection clip proposed in document EP3358647 is subject to deformations likely to affect its mechanical strength when the movable element passes from one of the engaged position and the disengaged position to the other of these two positions.

Furthermore, the effect of holding the connection tab in the U-shaped channel (and therefore the efficiency of the electrical connection) is ensured only by the spring action of the connection clip.

Thus, an object of the present disclosure is to propose a connection device for which the deformations undergone by the connection clip remain limited to those observed in document EP3358647.

Another aim of the present disclosure is to propose a connection device for which the clamping of the connection tab is not exclusively borne by the connection clip.

### BRIEF SUMMARY

The present disclosure relates to a connection device comprising:
a casing provided with a parallelepiped main body, which casing forms a main housing that is accessible by an insertion opening formed in a lower surface of the casing;
a connection element, which is arranged in the main housing and comprises two connection wings that are interconnected by a connection base;
a clamping clip, which is arranged in the main housing and comprises two clamping wings that are interconnected by a clamping base and are arranged on both sides of the connection element so as to apply a force by spring action on each of the connection wings, which force aims at tightening one connection wing against the other as soon as the clamping clip is in a free state;
a movable element, which is arranged in the main housing and comprises two lateral wings that are connected by a base, referred to as a mobile base, the lateral wings being arranged on both sides of the clamping clip, the movable element being capable of adopting a raised position or a lowered position, the lowered position being a position in which the movable element leaves the clamping clip in the free state thereof, while the raised position is a position in which the lateral wings have a spacing, referred to as the first spacing, which is greater than the spacing, referred to as the second spacing, viewed in the lowered position, and the lateral wings exert, on each of the clamping wings, a force opposing the spring action, which leads to the spacing of the clamping wings.

According to one embodiment, each clamping wing comprises a series of longitudinal bearing tabs that are parallel to one another and terminate the clamping wing by an edge, referred to as a bearing edge, which is opposite the clamping base, the bearing tabs of a given clamping wing being partially inserted by the free end thereof into housings, referred to as bearing housings, of the lateral wings so that when the lateral wings move away from one another, the lateral wings carry the clamping wings along in the movement thereof in order to also move the clamping wings apart.

According to one embodiment, the movable element is arranged so that the movement thereof from the raised position to the lowered position corresponds to a translation of the movable element from an upper surface of the casing to the lower surface thereof, the upper surface being parallel to and opposite the lower surface.

According to one embodiment, the main housing of the casing comprises a wedge on at least one front internal surface and one rear internal surface, the rear internal surface and the front internal surface being parallel to one another, the wedge being suitable for imposing on the lateral wings the first spacing when the movable element is in the raised position and the second spacing when the movable element is in the lowered position.

According to one embodiment, the lateral wings are perpendicular to the front internal surface and to the rear internal surface, each lateral wing comprising two side edges that are parallel to one another and extend from the base of the movable element, and at least one of the two side edges comprises a stop that engages with the wedge in order to impose either the first spacing or the second spacing on the lateral wings when the movable element is in, respectively, the raised position and the lowered position thereof.

According to one embodiment, the device comprises a lever that is arranged in the casing and is capable of adopting either a deployed position or a stowed position by pivoting about the pivot axis, the deployed position being a position in which the lever imposes on the movable element the raised position thereof, and the stowed position being a position in which the lever imposes on the movable element the lowered position thereof.

According to one embodiment, the lever comprises two lever arms that are parallel to one another and secured to one another, each lever arm comprising a shaft that passes through a slide formed in a wall of the casing, perpendicular to the pivot axis A, the shaft and the slide are arranged so that the shaft is guided into the slide when the lever pivots about the pivot axis, and the shaft engages with a groove formed in the mobile base in order to impose either the raised position or the lowered position on the movable element when the lever pivots.

According to one embodiment, the lever comprises two longitudinal elements that extend in a direction opposite the lever arms and are intended to engage with stops of a battery when the device is connected to a connection tab of the battery, the engagement being provided to prevent the device from disconnecting when the lever is in the stowed position.

According to one embodiment, the casing comprises a locking clip that is configured to lock the lever when it is in the stowed position.

According to one embodiment, the main body comprises two walls, referred to as side walls, that are arranged on both sides of the lateral wings, and in each of which a flexible projection is cut, which projection is terminated by a free end that is flush with the lower surface, and each flexible projection comprises a stop, referred to as a blocking stop, that projects internally into the main housing, each flexible projection engaging with the lateral wing that is directly adjacent thereto so as to be able to impose either the first or the second state on the device, the first state being a state in which each lateral wing is in abutment against a stop plane of the blocking stop of the flexible projection with which the wing engages, so as to prevent the movable element from adopting the lowered position thereof, while the second state is a state in which the flexible projections are bent so that each of the blocking stops is in what is known as a retracted position and thus allow the movable element to adopt the lowered position thereof.

According to one embodiment, each lateral wing comprises a counter stop cooperating with the blocking stop.

According to one embodiment, the blocking stop of each flexible projection comprises, in the direction of the free end thereof and in order, the stop plane and a spacing plane, the spacing plane being arranged so that an insertion tab sliding against the spacing plane in a direction perpendicular to the lower surface and in the plane of the side wall causes the flexible projection to bend and the blocking stop to be placed in a retracted position.

According to one embodiment, the side projection comprises a laterally offset portion that extends from the free end of the side projection and that is connected to a main portion of the projection by an intermediate portion supporting in part the spacing plane, the main portion and the laterally offset portion being parallel to one another.

According to one embodiment, the flexible projection comprises a generally planar portion that extends uniformly from the start to the free end thereof, and the blocking stop of the flexible projection comprises an inclined plane that is opposite the spacing plane relative to the stop plane, the inclined plane being configured so that the counter stop sliding against the inclined plane, when a force is exerted on the movable element in the direction of the lower surface, imposes an intermediate bend on the flexible projections, making it possible to place the counter stop in abutment against the blocking plane.

### BRIEF DESCRIPTION OF THE DRAWINGS

Other features and advantages of the invention will emerge from the following detailed description of a device for connecting a terminal of a battery module with reference to the appended figures, wherein:

FIG. 1 is a partial and perspective representation of a connection device according to a first embodiment of the present disclosure; in this FIG. 1, the device is shown with a lever in a deployed position so as to impose on the raised position on a movable element (not visible in this figure);

FIG. 2 is a perspective representation of the casing isolated from the connection device shown in FIG. 1;

FIG. 3 is a perspective representation of a connection element isolated from the connection device shown in FIG. 1;

FIG. 4 is a perspective representation of a clamping clip isolated from the connection device shown in FIG. 1;

FIG. 5 is a perspective representation of a movable element isolated from the connection device shown in FIG. 1;

FIG. 6 shows the connection device of FIG. 1 along a cross-sectional plane perpendicular to the side walls and parallel to the front wall;

FIG. 7 is a schematic representation of the connection device of FIG. 1, and along a cross-sectional plane perpendicular to the side walls and parallel to the front wall; the connection device is, in particular, shown in a phase, called a pre-connection phase, and in this phase, the terminal of a battery module is inserted between the two connection wings, and the movable element is in the raised position;

FIG. 8 is a schematic representing of the connection device of FIG. 1, and along a cross-sectional plane perpendicular to the side walls and parallel to the front wall; the connection device is, in particular, shown in a phase, called a connection phase, and in this phase, the terminal of a battery module is inserted between the two connection wings, and the movable element is in the lowered position;

FIG. 9 is a schematic representation in perspective view of the movable element wherein the clamping clip is inserted;

FIG. 10 is a schematic representation along a cross-sectional plane perpendicular to the side walls and parallel to the front wall; FIG. 10 in particular, shows the engagement between the wedge and the stops, in particular, in this figure, the wedge and the stops impose a spacing equal to the first spacing on the lateral wings;

FIG. 11 is a schematic representing along a cross-sectional plane perpendicular to the side walls and parallel to the front wall; FIG. 11 in particular, shows the engagement between the wedge and the stops, in particular, in this figure, the wedge is at a distance from the stops so that the lateral wings have a spacing equal to the second spacing;

FIG. 12 is a representation of the connection device of FIG. 1 and in a perspective view; in this figure, the device is provided with a lever in the stowed position;

FIG. 13 is a representation of the connection device of FIG. 1 and in a perspective view; in this figure, the device is provided with a lever in the deployed position;

FIG. 14 is a schematic representation of the lever isolated from the device shown in FIG. 12 and in FIG. 13;

FIG. 15 is a schematic representation of the connection device according to the first embodiment and provided with the lever; the lever is, in particular, shown by transparency so as to view the engagement between the slide and the shaft;

FIG. 16 is a schematic representation of the connection device of FIG. 1, and along a cross-sectional plane perpendicular to the side walls and parallel to the front wall; the connection device is, in particular, shown in a phase, called a pre-engagement phase, and in this phase, the terminal of a battery module is inserted between the two connection wings, and the movable element is in the raised position;

FIG. 17 is a schematic representation of the connection device of FIG. 1, and along a cross-sectional plane perpendicular to the side walls and parallel to the front wall; the connection device is, in particular, shown in a phase, called an engagement phase, and in this phase, the terminal of a battery module is inserted between the two connection wings;

FIG. 18 is a schematic representation of the connection device of FIG. 1, and along a cross-sectional plane perpendicular to the side walls and parallel to the front wall; the connection device is, in particular, shown in the connection state according to FIG. 8;

FIG. 19 is a partial perspective representation of a connection device according to a second embodiment of the present disclosure;

FIG. 20 is a schematic representation of the connection device of FIG. 19, and along a cross-sectional plane perpendicular to the side walls and parallel to the front wall; the connection device is, in particular, shown in a phase, called a pre-engagement phase, and in this phase, the movable element is in the raised position;

FIG. 21 is a schematic representation of the connection device of FIG. 19, and along a cross-sectional plane perpendicular to the side walls and parallel to the front wall; the connection device is, in particular, shown with flexible wings partially bent;

FIG. 22 is a schematic representation of the connection device of FIG. 19, and along a cross-sectional plane perpendicular to the side walls and parallel to the front wall; the connection device is, in particular, shown in a phase, called an engagement phase, and in this phase, the terminal of a battery module is inserted between the two connection wings; and

FIG. 23 is a representation of the connection device of FIG. 19 in the connection phase.

### DETAILED DESCRIPTION

The present disclosure relates to a connection device, and, in particular, a connection device intended to be implemented to establish electrical connections between battery cells.

In particular, the connection device according to the present disclosure comprises a casing provided with a generally parallelepiped portion, forming a main housing that is accessible by an opening formed on a lower surface of the casing.

A connection element is arranged in the main housing. This connection element comprises two connection wings that are interconnected by a connection base and that extend from the connection base to the opening of the casing.

A clamping clip is also arranged in the main housing. This clamping clip comprises two clamping wings that are interconnected by a clamping base and that extend from the clamping base to the opening. The two clamping wings are, in particular, arranged on both sides of the connection element and apply a force by spring action on each of the connection wings, which force aims at tightening one connection wing against the other as soon as the clamping clip is in a free state.

Finally, a movable element is arranged in the main housing. This movable element comprises two lateral wings connected by a base, called mobile base, that extend from the mobile base to the opening. The lateral wings are arranged on both sides of the clamping clip. The movable element is also capable of adopting a raised position or a lowered position. In these regards, the lowered position is a position wherein the movable element leaves the clamping clip in the free state thereof, while the raised position is a position in which the lateral wings have a spacing, referred to as the first spacing, that is greater than the spacing, referred to as the second spacing, viewed in the lowered position, and the lateral wings exert, on each of the clamping wings, a force opposing the spring action that leads to the spacing of the clamping wings.

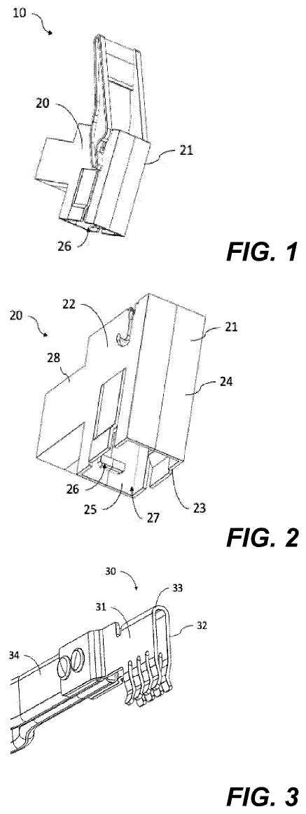

FIG. 1 shows an example of a connection device 10 of a terminal of a battery module according to a first embodiment of the present disclosure.

In these regards, the connection device 10 comprises a casing 20 made of an electrically insulating material.

The casing 20, also shown isolated in FIG. 2, comprises a main body 21 of generally parallelepiped shape.

In particular, the main body 21 comprises two side walls 22, 23, parallel to one another, as well as a front wall 24 and a rear wall 25 connecting the two side walls 22 and 23 together.

The main body 21 also delimits a main housing 26 that is accessible by an opening, called an insertion opening 27, formed on a lower surface of the casing 20. It is understood that the lower surface of the casing 20 is perpendicular to each of the side, front and rear walls.

The casing 20 may also comprise an extension 28, which is also of parallelepiped shape. The extension 28 is, in particular, contiguous with the rear wall 25 of the main body 21. In these regards, the extension 28 forms an open passage between two opposite faces of the extension 28 and communicating with the main housing 26, via an opening provided in the rear wall 25 of the main body 21.

The connection device 10 of FIG. 1 also comprises a connection element 30 arranged in the main housing 26.

The connection element 30, shown in isolation in FIG. 3, comprises two wings, referred to as connection wings 31 and 32, which are interconnected by a base, called a connection base 33. More particularly, the connection element 30 is arranged in the main housing 26 so that the connection wings 31 and 32 extend from the connection base to the insertion opening 27. It is understood, without it being necessary to specify it, that the connection element 30 is held fixed in the main housing 26 (in fixed connection). In particular, the holding in fixed connection of the connection element 30 in the main housing 26 may involve a bus bar 34, passing through the open passage. In particular, the bus bar can pass at least partially through the extension 28, in order to come into contact with the connection element. Clamping against the walls of the extension 28 of the connection element 30 and/or of the bus bar makes it possible to hold the connection element 30 fixed in the main housing 26.

The connection element 30 may comprise an electrically conductive material and, in particular, copper, a copper alloy, aluminum, or an aluminum alloy.

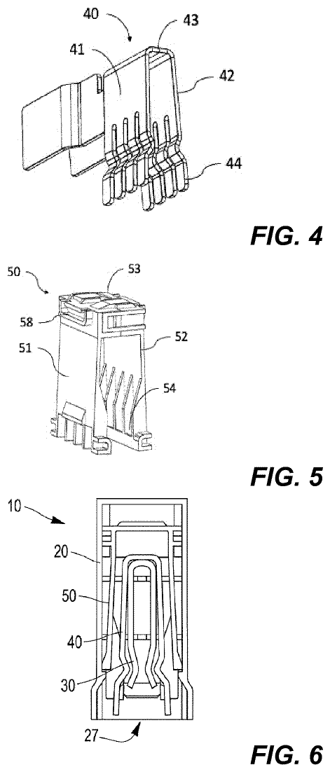

The connection device 10 also comprises a clamping clip 40 arranged in the main housing 26 (FIG. 4). The clamping clip 40 comprises two wings, referred to as clamping wings 41, 42, that are interconnected by a base, referred to as a clamping base 43, and that extend from the clamping base 43 to the insertion opening 27. The two clamping wings 41 and 42 are, in particular, arranged on both sides of the connection element 30 and are intended to apply a force by spring action on each of the connection wings 31, 32 aimed at tightening one of them against the other as soon as the clamping clip 40 is in a so-called free state.

It is understood that the connection element 30 and the clamping clip 40 each have a U-shaped portion, and are arranged in a “concentric” manner (so that the clamping clip will house, between its clamping wings, the connection element 30). In these regards, the clamping base 43 and the connection base 33 may be in contact with one another.

It is also understood that the clamping clip is held fixed in the main housing 26. In this respect, the clamping clip 40 can be attached to the connection element 30.

The connection device 10 comprises a movable element 50 that is also arranged in the main housing 26 (FIG. 5). The movable element 50 comprises two wings, referred to as lateral wings 51, 52, that are connected by a base, called a mobile base 53. Each lateral wing extends from the mobile base, between two edges called side edges, to the insertion opening 27. The lateral wings 51, 52 are also arranged on both sides of the clamping clip 40.

Thus, and as shown in FIG. 6, the connection element 30, the clamping clip 40, and the movable element 50 are arranged concentrically in the main housing 26 of the main body 21. More particularly, the connection element 30 is arranged between the clamping wings 41, 42, while the clamping clip 40 in turn is placed between the lateral wings 51, 52.

Additionally, the movable element 50 can adopt one or the other of a raised position and a lowered position. The lowered position is a position for which the movable element 50 leaves the clamping clip 40 in its free state. In other words, the lowered position is a position for which the clamping wings 41, 42 exert a force on the connection wings aimed at tightening them one against the other, and as a result, reducing their spacing.

The raised position is a position in which the lateral wings have a spacing, referred to as the first spacing, that is greater than the spacing, referred to as the second spacing, viewed in the lowered position, and the lateral wings exert, on each of the clamping wings, a force opposing the spring action that leads to the spacing of the clamping wings.

In other words, the passage of the movable element 50 from the raised position to the lowered position makes it possible to free the tension exerted by the clamping clip so that the latter applies a force aimed at tightening the connection wings. In contrast, the passage of the movable element from the lowered position to the raised position is reflected by a spacing of the lateral wings. In their movement, the latter move the clamping wings, which then no longer exert any clamping force on the connection wings.

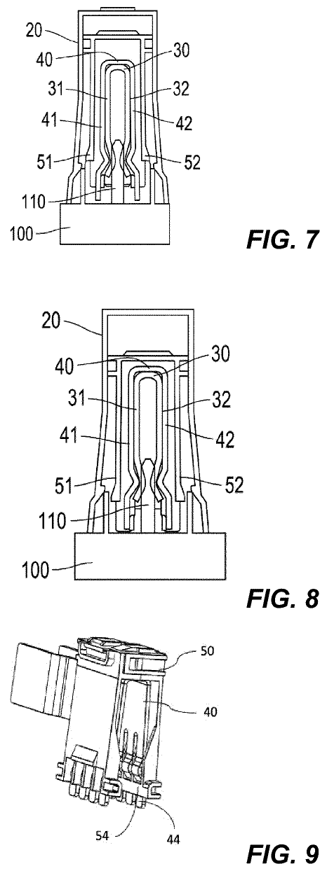

The implementation of the connection device 10 according to the present disclosure for connecting a terminal 110 of a battery module 100 is shown in FIGS. 7 and 8.

In particular, FIG. 7 is a schematic representation of the connection device 10 in a so-called pre-connection phase. In this phase, the terminal 110 is inserted between the two connection wings 31, 32, and the movable element 50, in the raised position, holds the clamping wings away from the connection wings. In other words, the clamping wings 41, 42 do not exert any force on the connection wings 31, 32.

FIG. 8 is a schematic representation of the connection device of FIG. 7 in a so-called connection phase. In this phase, the terminal 110 is inserted between the two connection wings 31, 32, and the movable element 50 is in the lowered position. In other words, the lateral wings are spaced apart according to their second spacing, and exert no force on the clamping wings opposing the spring action. The clamping wings 41, 42 are thus free to exert a force (by spring action) on the connection wings 31, 32 aimed at tightening them one against the other so that the latter retain the terminal 110.

It is understood that the passage of the movable element from one of the raised position or the lowered position to the other of these positions corresponds to a movement of the movable element in the main housing 26 in a direction perpendicular to the lower surface, referred to as the direction of movement. More particularly, the passage from the raised position to the lowered position corresponds to a movement of the movable element in the direction of movement and in a direction from an upper surface of the main body to its lower surface, the upper surface being opposite the lower surface. In an equivalent manner, the passage from the lowered position to the raised position corresponds to a movement of the movable element in the direction of movement and in a direction from the lower surface to the upper surface.

Particularly advantageously, each clamping wing 41, 42 comprises a series of longitudinal bearing tabs 44 parallel to one another and terminating the clamping wing by an edge, called the bearing edge, opposite the clamping base (FIGS. 4 and 9). The bearing tabs 44 of a given clamping wing are partially inserted by their free end into housings, called bearing housings 54 (FIGS. 5 and 9), of the lateral wings. Thus, when they are spaced apart from one another, the lateral wings drive the movement of the clamping wings in order to space them apart as well.

The level of spacing of the lateral wings 51, 52 of the movable element 50, whether it is in the raised position or in the lowered position, is imposed by one or two wedges 29 (hereinafter “the wedges”). In particular, the wedges can be arranged, respectively, on both the front wall and the rear wall and project inwardly to the main housing 26. In other words, a front inner surface of the front wall comprises one wedge, while a rear inner surface of the rear wall comprises the other wedge.

More particularly, the profile of each of the wedges is adapted to impose, on the lateral wings, the first spacing when the movable element is in the raised position, and the second spacing when the movable element is in the lowered position.

In this respect, each lateral wing may comprise, on its side edges, a stop cooperating with one of the wedges to impose one or the other of the first and second spacings on the lateral wings when the movable element is in, respectively, its raised position and its lowered position.

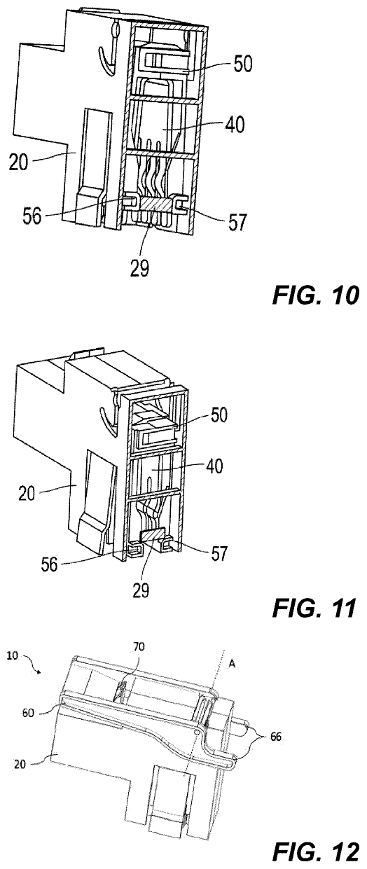

For example, and as shown in FIGS. 10 and 11, the movable element 50 is shown with two stops 56 and 57 opposite one another and arranged on the two directly adjacent side edges of the front inner surface of the main body.

The wedge 29 is arranged on the front inner surface so as to engage with the stops 56 and 57 in order to impose one or the other of the first and the second spacings when the movable element 50 is, respectively, in its raised position and in its lowered position. More particularly, as soon as the movable element 50 is in its raised position, the wedge 29 is interposed between the stops 56 and 57 so as to maintain a spacing of the two lateral wings that is equal to the first spacing.

In an equivalent manner, as soon as the movable element 50 is in its lowered position, the wedge is set back from the stops 56 and 57, thus allowing the lateral wings to move closer to one another until they have a spacing equal to the second spacing.

Furthermore, in order to facilitate the passage from one to the other of the raised position and the lowered position, the wedge 29 and/or the stops 56 and 57 may have rounded or beveled corners.

The aspects disclosed above in relation to the front internal surface and the side edges (referred to as front side edges) that are directly adjacent thereto are also applicable to the rear internal surface and the side edges, referred to as rear side edges, opposite the front side edges.

The connection device 10 may advantageously comprise a lever 60, mounted on the casing. The lever 60 is capable of adopting one or the other of a deployed position and a stowed position by pivoting about a pivot axis A. More particularly, the lever 60 is configured to impose either of the raised position and the lowered position on the movable element.

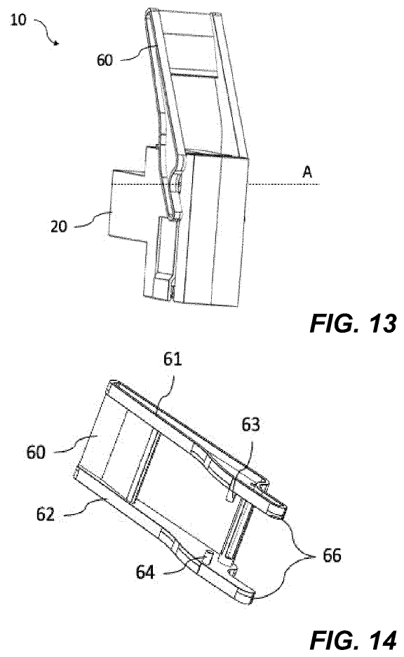

In particular, the deployed position (FIG. 13) is a position for which the lever 60 imposes the raised position on the movable element 50, while the stowed position (FIG. 12) is a position for which the lever 60 imposes the lowered position on the movable element 50.

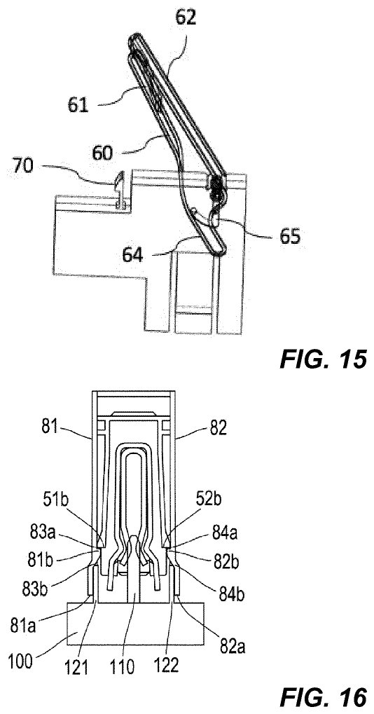

The lever 60 can comprise two lever arms 61, 62 that are parallel to one another, and secured to one another (FIG. 14). Each lever arm 61, 62 may comprise a shaft 63, 64 passing through a slide 65 (FIG. 15) formed in a side wall of the main body (it is understood that each shaft opens into the main housing). The shaft and the slide are arranged so that, on the one hand, the shaft is guided in the slide during the pivoting of the lever about the pivot axis, and on the other hand, the shaft engages with a groove 58 formed in the mobile base 53 in order to impose either of the raised position and the lowered position on the movable element during the pivoting of the lever.

Still advantageously, the lever comprises two longitudinal elements 66 that extend in a direction opposite the lever arms and are intended to engage with stops of a male element when the device is connected to a connection terminal of the battery, the engagement being provided to prevent the device from disconnecting when the lever is in the stowed position.

The casing may also be provided with a locking clip 70 that is configured to lock the lever when it is in the stowed position (FIG. 12).

The connection device according to this first embodiment may also comprise engagement means intended to block the passage of the movable element from its raised position to its lowered position as long as the connection terminal of the battery module is not correctly plugged in between the connection wings 31, 32.

In particular, and as shown in FIGS. 16-18, the engagement means may comprise two flexible projections 81, 82 respectively cut into each of the side walls 22, 23 of the main body 21. The flexible projections 81 and 82 are thus arranged on both sides of the lateral wings 51, 52. The flexible projections 81, 82 extend from their origin toward their free end 81a, 82a in the direction of movement and in the direction of the upper surface to the lower surface.

More particularly, the free end 81a, 82a of each flexible projection 81, 82 is flush with the lower surface.

Each flexible projection also comprises a stop, referred to as the blocking stop 81b, 82b, projecting inwardly into the main housing 26, and each flexible projection 81 and 82 engages with the lateral wing 51, 52 that is directly adjacent thereto so as to be able to impose either of a first state and a second state on the device. The first state is a state for which each lateral wing 51, 52 is in abutment against a stop plane of the blocking stop of the flexible projection 81 and 82 with which it cooperates so as to prevent the movable element 50 from adopting its lowered position. The second state is a state for which the flexible projections 81 and 82 are bent so as to allow the movable element to adopt its lowered position. In other words, the second state is a state for which the lateral wings 51, 52 are no longer in abutment against the blocking stops 81b, 82b.

The bending of the flexible projections 81 and 82 may, in particular, be initiated during a pushing of the connection device 10 toward the terminal to be plugged in. More particularly, the flexible projections 81, 82 can be configured to bend during the pushing by engaging with tabs, called insertion tabs 121, 122, arranged proximate to the terminal 110, and each in alignment with a flexible projection 81, 82.

Each lateral wing may comprise a counter stop 51b, 52b cooperating with the blocking stop.

More particularly, the blocking stop of each flexible projection 81, 82 may comprise, in the direction of its free end 81a, 82a and in order, the stop plane 83a, 84a and a spacing plane 83b, 84b (FIG. 16). The spacing plane 83b, 84b is, in particular, arranged so that the sliding of an insertion tab 121, 122 against the spacing plane 83b, 84b in a direction perpendicular to the lower surface and in the plane of the side wall causes the flexible projection to bend and the blocking stop 81b, 82b to be placed in the retracted position. It is understood, without it having to be specified, that the spacing plane 83b, 84b forms a plane that is oblique relative to the direction of elongation of the flexible projection 81, 82.

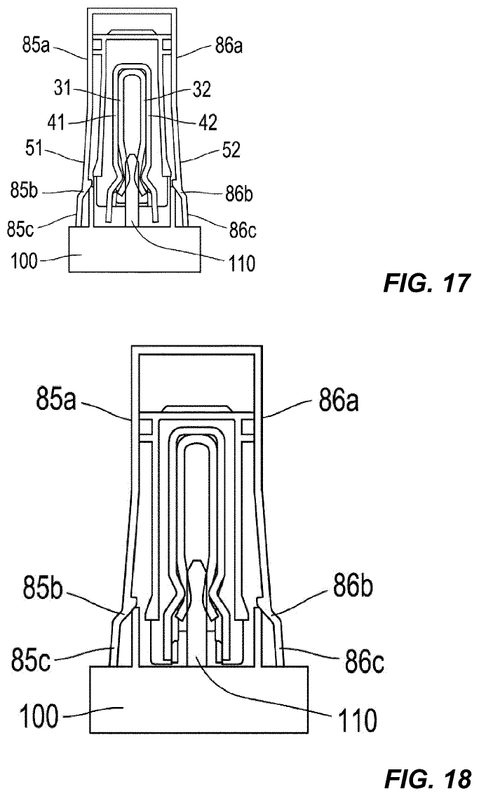

According to this first embodiment, the spacing plane 83b, 84b of a flexible projection 81, 82 is, in particular, carried by an intermediate portion 85b, 86b of the flexible projection connecting a main portion 85a, 86a and a terminal portion 85c, 86c of the flexible projection (FIG. 17). More particularly, the terminal portion 85c, 86c is laterally shifted. “Laterally shifted” means offset laterally relative to the direction of elongation of the main portion.

Thus, the implementation of the connection device 10 according to this first embodiment may comprise at least two phases referred to respectively as the pre-engagement phase and the engagement phase.

In this respect, FIG. 16 shows the pre-engagement phase. During the execution of this phase, the connection device 10 is positioned by its lower surface opposite a terminal 110 of a battery module 100, and so as to partially insert the terminal between connection wings. At the end of this phase, each of the terminal portions 85c and 86c laterally contacts an insertion tab 121, 122 so that each insertion tab bears against a spacing plane 83b, 84b.

The pre-engagement phase is then followed by the engagement phase (FIG. 17). This phase makes it possible to induce bending of the flexible projections in order to place the blocking stops 81b, 82b in the retracted position. This bending occurs, in particular, as soon as a pushing force is exerted on the connection device in a direction from the upper surface to the lower surface. More particularly, during the execution of the pushing force, each insertion tab requires bending of the flexible projections.

The lever 60 can then be actuated in order to cause the movable element to pass from its raised position to its lowered position (FIG. 18).

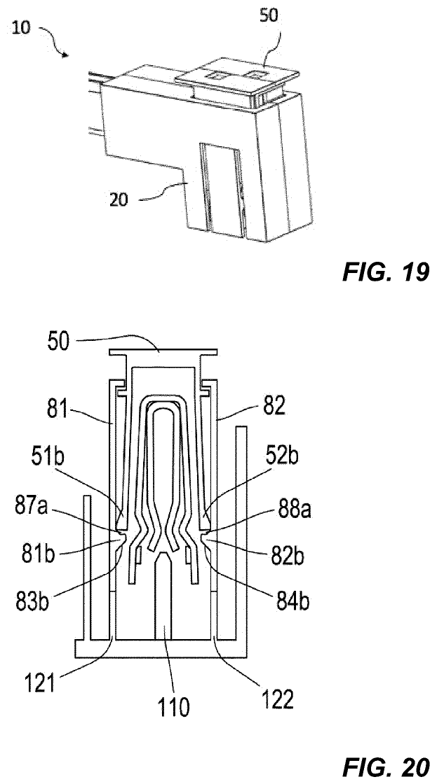

The present disclosure also relates to a second embodiment. This second embodiment essentially takes up the elements of the first embodiment. This second embodiment does not necessarily require a lever 60. More particularly, the movable element 50 can form a push button directly accessible by the upper surface (FIG. 19). In other words, a simple pressing force exerted on the movable element allows the latter to pass from its raised position to its lowered position.

Furthermore, still according to this second embodiment, the flexible projections 81, 82 extend uniformly from their origin to their free end 81a, 82a. In other words, the flexible projections 81, 82 do not comprise any laterally shifted terminal section 85c, 86c (FIG. 20). Thus, in the pre-engagement phase, the insertion tabs 121, 122 are each in the extension of a flexible projection 81, 82 and thus prevent any movement of the connection device aiming to establish the connection with the terminal 110.

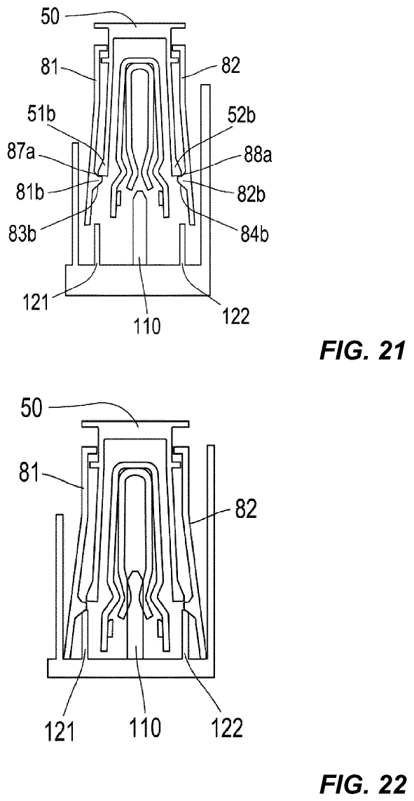

Furthermore, according to this second embodiment, the blocking stops each comprise an inclined plane 87a, 88a opposite the spacing plane relative to the stop plane. These inclined planes 87a, 88a are arranged so that a sliding of the counter stops against one and the other of the spacing planes 83b, 84b, in the direction of movement and the direction from the upper surface to the lower surface, induces a partial bending of the flexible projections. In particular, the partial bending makes it possible to separate the flexible projections from the insertion tabs (FIG. 21). An additional force exerted on the connection device 10 then makes it possible to bring each of the spacing planes 83b, 84b into contact with the insertion tabs 121, 122.

The rest of the engagement, shown in FIG. 22, follows a mechanism equivalent to the one disclosed in relation to the first embodiment.

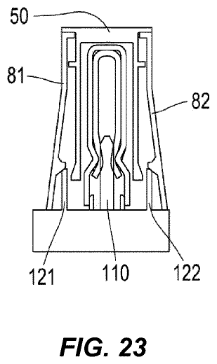

A final pushing (shown in FIG. 23) makes it possible to take the movable element 50 into its lowered position.

Of course, the present disclosure is not limited to the described embodiments and variant embodiments may be envisaged without departing from the scope of the invention as defined by the claims.

1. A connection device, comprising:
a casing including a parallelepiped main body, the casing forming a main housing is accessible by an insertion opening at a lower surface of the casing;
a connection element arranged in the main housing and having two connection wings interconnected by a connection base;
a clamping clip, arranged in the main housing and having two clamping wings interconnected by a clamping base and arranged on both sides of the connection element so as to apply a force by spring action on each of the connection wings, the force causing tightening of one connection wing against the other when the clamping clip is in a free state; and
a movable element arranged in the main housing and having two lateral wings connected by a mobile base, the lateral wings being arranged on both sides of the clamping clip the movable element being capable of adopting a raised position or a lowered position, the lowered position being a position in which the movable element leaves the clamping clip in the free state thereof, while the raised position is a position in which the lateral wings have a first spacing, which is greater than a second spacing in the lowered position, and wherein the lateral wings exert, on each of the clamping wings, a force opposing the spring action, which leads to the second spacing of the clamping wings.

2. The device of claim 1, wherein each clamping wing comprises a series of longitudinal bearing tabs that are parallel to one another and terminate the clamping wing by a bearing edge, which is opposite the clamping base, the bearing tabs of a given clamping wing being partially inserted by the free end thereof into bearing housings, of the lateral wings so that when the lateral wings move away from one another, the lateral wings carry the clamping wings along in the movement thereof in order to also move the clamping wings apart.

3. The device of claim 2, wherein the movable element is arranged so that the movement thereof from the raised position to the lowered position corresponds to a translation of the movable element from an upper surface of the casing toward the lower surface thereof, the upper surface being parallel to and opposite the lower surface.

4. The device of claim 3, wherein the main housing of the casing comprises a wedge on at least one front internal surface and one rear internal surface, the rear internal surface and the front internal surface being parallel to one another, the wedge being configured to impose on the lateral wings the first spacing when the movable element is in the raised position and the second spacing when the movable element is in the lowered position.

5. The device of claim 4, wherein the lateral wings are perpendicular to the front internal surface and to the rear internal surface, each lateral wing comprising two side edges that are parallel to one another and extend from the base of the movable element, and at least one of the two side edges comprises a stop that engages with the wedge in order to impose either the first spacing or the second spacing on the lateral wings when the movable element is in, respectively, the raised position and the lowered position thereof.

6. The device of claim 5, further comprising a lever arranged in the casing and capable of adopting either a deployed position or a stowed position by pivoting about a pivot axis, the deployed position being a position in which the lever imposes on the movable element the raised position thereof, and the stowed position being a position in which the lever imposes on the movable element the lowered position thereof.

7. The device according to claim 6, wherein the lever comprises two lever arms that are parallel to one another and secured to one another, each lever arm comprising a shaft that passes through a slide formed in a wall of the casing perpendicular to the pivot axis, the shaft and the slide being arranged so that the shaft is guided into the slide when the lever pivots about the pivot axis, and the shaft engages with a groove formed in the mobile base to impose either the raised position or the lowered position on the movable element when the lever pivots.

8. The device of claim 7, wherein the casing comprises a locking clip configured to lock the lever when it is in the stowed position.

9. The device of claim 8, wherein the main body comprises two side walls arranged on both sides of the lateral wings, and in each of which a flexible projection is cut, which projection is terminated by a free end flush with the lower surface, and each flexible projection comprises a blocking stop that projects internally into the main housing, each flexible projection engaging with the lateral wing that is directly adjacent thereto so as to be able to impose either a first state or a second state on the device, the first state being a state in which each lateral wing is in abutment against a stop plane of the blocking stop of the flexible projection with which the wing engages, so as to prevent the movable element from adopting the lowered position thereof, while the second state is a state in which the flexible projections are bent so that each of the blocking stops is in a retracted position and thus allow the movable element to adopt the lowered position thereof.

10. The device of claim 9, wherein each lateral wing comprises a counter stop that engages with the blocking stop.

11. The device of claim 10, wherein the blocking stop of each flexible projection comprises, in a direction of the free end thereof and in order, a stop plane and a spacing plane, the spacing plane being arranged so that an insertion tab sliding against the spacing plane in a direction perpendicular to the lower surface and in the plane of the side wall causes the flexible projection to bend and the blocking stop to be placed in a retracted position.

12. The device of claim 11, wherein the flexible projection comprises a laterally offset portion that extends from the free end of the flexible projection and that is connected to a main portion of the projection by an intermediate portion supporting in part the spacing plane.

13. The device of claim 11, wherein the flexible projection comprises a generally planar portion that extends uniformly from a start to the free end thereof, and the blocking stop of the flexible projection comprises an inclined plane that is opposite the spacing plane relative to the stop plane, the inclined plane being configured so that the counter stop sliding against the inclined plane, when a force is exerted on the movable element in the direction of the lower surface, imposes an intermediate bend on the flexible projections, making it possible to place the counter stop in abutment against the stop plane.

14. The device of claim 12, wherein the main portion and the laterally offset portion being parallel to one another.

15. The device of claim 1, wherein the movable element is arranged so that the movement thereof from the raised position to the lowered position corresponds to a translation of the movable element from an upper surface of the casing toward the lower surface thereof, the upper surface being parallel to and opposite the lower surface.

16. The device of claim 15, wherein the main housing of the casing comprises a wedge on at least one front internal surface and one rear internal surface, the rear internal surface and the front internal surface being parallel to one another, the wedge being configured to impose on the lateral wings the first spacing when the movable element is in the raised position and the second spacing when the movable element is in the lowered position.

17. The device of claim 16, wherein the lateral wings are perpendicular to the front internal surface and to the rear internal surface, each lateral wing comprising two side edges that are parallel to one another and extend from the base of the movable element, and at least one of the two side edges comprises a stop that engages with the wedge to impose either the first spacing or the second spacing on the lateral wings when the movable element is in, respectively, the raised position and the lowered position thereof.

18. The device of claim 3, further comprising a lever arranged in the casing and capable of adopting either a deployed position or a stowed position by pivoting about a pivot axis, the deployed position being a position in which the lever imposes on the movable element the raised position thereof, and the stowed position being a position in which the lever imposes on the movable element the lowered position thereof.

19. The device of claim 1, wherein the main body comprises two side walls arranged on both sides of the lateral wings, and in each of which a flexible projection is cut, which projection is terminated by a free end flush with the lower surface, and each flexible projection comprises a blocking stop that projects internally into the main housing, each flexible projection engaging with the lateral wing that is directly adjacent thereto so as to be able to impose either a first state or a second state on the device, the first state being a state in which each lateral wing is in abutment against a stop plane of the blocking stop of the flexible projection with which the wing engages, so as to prevent the movable element from adopting the lowered position thereof, while the second state is a state in which the flexible projections are bent so that each of the blocking stops is in a retracted position and thus allow the movable element to adopt the lowered position thereof.

20. The device of claim 19, wherein each lateral wing comprises a counter stop that engages with the blocking stop.
